(19) United States
(12) Patent Application Publication
(10) Pub. No.: US 2009/0130311 A1
(43) Pub. Date: May 21, 2009

(54) DECORATED ARTICLES

(75) Inventors: David Brull, Limbourg (BE); Robert Frere, Plombieres (BE); Jean-Pierre Mayeres, Eupen (BE); Emmanuel Noel, Eupen (BE); Denis Job, Angleur (BE)

Correspondence Address: CANTOR COLBURN, LLP, 20 Church Street, 22nd Floor, Hartford, CT, 06103, US

(73) Assignee: NMC S.A., Raeren/Eynatten (BE)

(21) Appl. No.: 11/577,901

(22) PCT Filed: Oct. 24, 2005
(86) PCT No.: PCT/EP05/55479

§ 371 Date: Apr. 25, 2007

(30) Foreign Application Priority Data
Oct. 27, 2004 (EP) 04025533.3

(51) Int. Cl. B44C 1/16

(52) U.S. Cl. 427/275; 118/44

(57) ABSTRACT

The invention relates to a method for the continuous, single-step application of a decoration to at least one face of articles made from an extruded- or foamed-plastic material. The aforementioned step comprises: (i) the embossing of at least one face of the article, by passing the article under an embossing roller which is equipped with a relief groove; and (ii) the printing of said at least one face of the article with the transfer of an ink from a composite film with transferable ink. The printing step is performed concomitantly with the embossing step with the same embossing roller which is made form an elastic material and which is heated to the surface softening temperature of the plastic article. The invention also relates to a device for decorating extruded- and foamed-plastic articles in a single step, to the articles thus decorated and to the use of the method and the device.

### TECHNICAL FIELD

The present invention relates to a method for decorating articles made of plastic, especially profiles made of extruded and foamed plastic, whereby this decoration imitates particularly realistically the aspect of natural materials, for example that of wood.

### PRIOR ART

Decorative profiles made of extruded and foamed plastic, such as mouldings, are attractive because of their lightness in comparison with mouldings made of plaster, wood or natural stone. Plastics of the polystyrene type (crystal PS, HIPS, ABS, PS+PPO, . . . ) and polyvinyl type, such as polyvinyl chloride (PVC), can be cited inter alia among the extrudable and foamable thermoplastics that may be used for this type of product.

Decorative wooden mouldings are generally used for door frames, skirting boards, picture rails, photo or picture frames, etc. Genuine wooden mouldings are available in various densities depending on the chosen species of tree, but must be regularly looked after if their attractive quality and appearance are to be maintained. The problems associated with the natural resources of wood cannot be ignored; supplies are not infinite and although they are a renewable resource, the growth cycles can be long and can also result in ecological problems in the case of excessive demand.

Sawdust can be recovered from a variety of industries and can be recycled by extrusion in a thermoplastic matrix (PP, PVC, HDPE, . . . ) to afford a decorative profile with an appearance approaching that of wood, but with neither the texture nor the finish of this noble material.

A method employed by the person skilled in the art consists in covering the decorative profiles made of foamed and extruded plastic with a film that imitates the appearance of wood so as to make them more attractive and to match them to specific interiors. The commonest method consists in transferring a roll of film made of plastic, on which is deposited a transferable ink (transfer method), onto the visible surface of the sufficiently cooled moulding. The method is accomplished by means of a roller made of a flexible material, most frequently a silicone rubber. The roller presses the film onto the surface of the foamed PS profile to be decorated, and, under the action of heat, the paint is transferred perfectly onto the profile. The smoother the initial surface (without ridges or imperfections), the better the result.

The obtained result consists in a perfectly smooth and flat coating that imitates the colours of the wood grain. However, this configuration produces a “glossy plastic” effect that is very different from the relief effect of a real wooden moulding.

One possibility for increasing the realism of the wood aspect finish is to press the ink film of imitation wood grain onto the surface of the moulding, but by incorporating veins, i.e. that the profile surface is no longer flat, but scored here and there with channels, for example, that the paint should fill as much as possible. Light shining on this type of decorated surface will no longer be reflected uniformly; there will be “shadows” that more faithfully reproduce the imperfections present on the wooden moulding. These veins or channels can be produced in a high-pressure press in a discontinuous method.

On attempting to apply this advantageous modification of the appearance of the ink with a wood effect in a continuous method by means of a metal roller exhibiting ridges and channels on its surface, the heated roller is pressed onto the film of paint to be transferred, but the paint separates and peels off from the areas that are not perfectly flat; the result is unsatisfactory.

A known decoration method for a visible surface of an extruded plastic profile is also that of covering the surface with a sheet exhibiting an imitation of the appearance of wood. The sheet can be composed of one or a plurality of resins, or of paper, coloured with wood grain patterns or comprising particles, and embossed before or after coloration to create hollows and bumps that imitate the texture of wood. This ready for use sheet is applied onto the relevant surface of the decorative moulding by hot lamination or by continuous gluing. Nevertheless, this method requires the use of special adhesives that may comprise solvents that can be toxic and involve handling problems.

Another original method is described in WO 99/28114 (ROBOBOND LIMITED) for painting a surface of the continuously extruded moulding, wherein a continuously unrolled intermediate film made of paper or plastic is applied by pressing onto paint that is still wet and malleable by means of a roller, wherein the roller of malleable plastic or the metal can have engraved designs. The intermediate film is subsequently reeled up, leaving the ribbed paint on the surface, which is finally dried. Advantageously, the intermediate film is crumpled beforehand to enhance the finish of the appearance of wood. This method selectively alters the thickness of the applied paint, which has the disadvantage of reducing the scratch resistance and peel resistance of the paint layer, due to its variable thickness. Moreover, this method comprises several steps that must be carefully controlled and does not allow fine and complex patterns to be created.

In summary, all the methods from the prior art have at least one of the following disadvantages: they do not allow plastic profiles to be obtained that imitate not only the aspect but also the texture of a natural material, they require several separate and/or discontinuous steps, they require the use of special adhesives and/or toxic solvents, the quality of the finish is not satisfactory.

### OBJECT OF THE INVENTION

Accordingly, it is an object of the present invention to propose a simple, continuous method for decorating plastic articles, including both the aspect and the texture, for example by realistically imitating natural materials.

According to the invention, this object is achieved by a method according to claim 1.

### GENERAL DESCRIPTION OF THE INVENTION

In order to solve the problem mentioned above, the present invention proposes a one-step method for decorating at least one surface of extruded and foamed plastic articles, said step comprising:

embossing the at least one surface of the article by passing it under an embossing roller provided with a raised groove and

printing the at least one surface of the article by transferring an ink from a transferable ink composite film.

The method is characterised in that said printing is effected at the same time as the embossing by the same embossing roller, said roller being made of an elastic material heated to the softening temperature of the surface of the plastic article.

The present decoration method is simple, in that it combines in one step both the application of any type of pattern (printing) and effects a superficial structure (embossing) on a plastic article. Moreover, it is a continuous method, thereby ensuring high throughputs and hence an increased profitability.

Nevertheless, the key point of the method is the resulting quality obtained. Firstly, the use of the inventive method, for example to manufacture imitation wood profiles, produces decorations with a much more realistic finish. Secondly, thanks to this method, the ink is perfectly applied and exactly fits the relief created by the embossing roller, thereby affording a sealed and resistant surface.

Another non-negligible advantage of the present method is its versatility. In fact, the decorations can be almost infinitely varied in the choice of pattern, as well as in the selected type of grain. Moreover, it can also be used for all sorts of articles, such as, for example elongated profiles, but also articles with other dimensions, especially as it can be easily adapted for the decoration of several faces of the same article.

Finally, the method according to the invention requires neither the use of toxic solvents, nor that of special adhesives and generates practically no waste, all of which reduces capital investment and running costs, and therefore production costs.

Surprisingly, we have found, and contrary to the advice of companies specialised in this type of decoration method, that by using an embossing roller made of relatively flexible material and exhibiting a relief, such as, for example, longitudinal ridges and channels on the whole of the perimeter and width of the surface, the ink film is applied perfectly and fills in the channels created on the surface of the profile without tearing the film and without risk of any subsequent peeling.

The choice of the elastic and flexible material for pressing the composite film comprising the transferable ink, together with the method conditions (heating temperature and application pressure), are critical for obtaining an attractive effect.

In principle, the elastic embossing roller can be made of any material that is sufficiently flexible to avoid tearing of the ink film. The elastic material of the roller is preferably elastomeric, possessing a sufficient heat resistance so as not to deform in the temperature range to which it is heated. Silicone rubbers possess ideal characteristics of resilience, heat resistance and hardness to satisfy these criteria; they are currently used in industry because of these properties. Accordingly, the silicone rubber is a particularly appropriate material.

The hardness of the elastic material of the embossing roller, is chosen in consideration of the other method parameters, such as the type of ink film, the type of plastic of the article, etc. In other words, this hardness will be chosen as a function of the ease of obtaining the veined effect, and is generally between 40 and 90 Shore A, preferably between 60 and 80 Shore A.

To obtain the relief, such as ridges, on the elastic and flexible plastic of the roller used for decorating the surface of the plastic moulding, various methods known to the person skilled in the art are available. For example, the surface can be milled, or the material can be moulded in a mould exhibiting surface ridges that will be reproduced in the negative in the plastic material during its curing. As already mentioned above, this allows the decoration to be varied at will, for example by using a relief imitating wood grain, the grain of natural stones or any geometrical structure, simply by changing the embossing roller and/or the pattern of the transferable ink film.

Transferable ink films are conventional films known to the person skilled in the art, for example: bottle, automobile, graphic industry in general . . . .

The preheating temperature for the elastic material of the embossing roller and the application pressure of the roller for transferring the ink onto the profile will be adapted so as to provide a sufficient softening of the surface of the plastic profile such that the ridges are negatively impressed and the decorative ink is transferred correctly therein. The parameters that can influence the choice of this temperature and this pressure are, inter alia, the type of plastic used, the density and the surface hardness of the foamed profile. Remarkably, these conditions of temperature and pressure fall outside the usual values recommended by the manufacturers of embossing rollers for these applications; one generally works under much milder conditions than those of the present invention, as the materials to be grained are mostly malleable or become malleable (paints, inks, flexible coatings deposited onto the surface of the mouldings). Generally speaking, the softening temperature at the surface is between 160 and 200° C., preferably between 170 and 180° C.

In principle, the temperature of the embossing roller can be regulated by any method that allows the surface of the relief of the roller to be maintained at the softening temperature of the surface of the articles being decorated, preferably by means of a heating device separated by external radiation.

The plastic articles that can be used in the present method are conventional extruded articles and foams used in this field. Methods for the manufacture of thermoplastic or non-thermoplastic foams by extrusion are known to the person skilled in the art. Extrusion offers an evident productivity advantage.

These articles, most often extruded and foamed plastic profiles, are preferably made of thermoplastic materials to enable their recycling. The selected polymers advantageously demonstrate a sufficiently high mechanical strength to guarantee an acceptable rigidity, especially for the case when cutting lengths of several metres. Among the polymers that meet these criteria, may be cited, inter alia, the optionally modified thermoplastic (co)polymers, such as crystal polystyrene (PS), impact polystyrene (HIPS), poly(styrene-acrylonitrile) (SAN), poly(acrylonitrile-butadiene-styrene) (ABS) and polyvinyl chloride (PVC), as well as their blends, optionally combined with other thermoplastic polymers, such as for example polyphenylene oxide (PPO), like Noryl (PS+PPO). Crystal polystyrene is a particularly suitable polymer for the fabrication of light and resistant decorative mouldings.

The density of foam profiles that can be decorated by means of the method of the present invention can vary between 60 and 700 kg/m³, preferably between 150 and 400 kg/m³.

A further object of the present invention concerns a device for decorating extruded and foamed plastic articles in one step, said device comprising:

a conveying device for feeding the plastic article,

an embossing roller provided with a ridged surface,

A heating device for heating the embossing roller,

a feeding reel and a wind-up reel for a transferable ink composite film,

in which the plastic article is moved by the conveying means under the embossing roller that rotates at the conveying speed of the plastic article, said transferable ink composite film coming from the feed reel, being fed between the plastic article and the embossing roller, the roller being made of an elastic material and heated to the softening temperature of the surface of the plastic article.

An additional aspect of the invention concerns a decorated plastic article obtained by means of a method or by a device such as those described above.

Finally, the present invention anticipates the use of a method or a device, such as those described above, for continuously effecting a decoration in one step on at least one surface of extruded and foamed plastic articles, in particular for the production of decorated mouldings, skirting boards, picture rails and frames.

Naturally, the articles can be subjected to additional treatments before or after the present method, for example cutting the profiles to size, etc., and although not usually needed, other finishing steps.

### BRIEF DESCRIPTION OF THE DRAWINGS

Other distinctive features and characteristics of the invention will become evident from the detailed description of several advantageous illustrative embodiments presented below, by referring to the appended drawing:

FIG. 1 is a diagramme of the principle of an embodiment of a decorating device according to the invention.

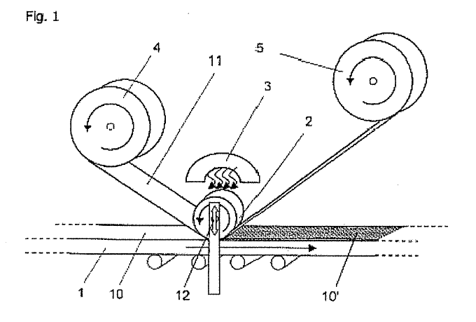

### DESCRIPTION OF A PREFERRED MODE OF REALISATION

The decoration device comprises an embossing roller 2, made for example of silicone rubber, and held above a conveying device or a counter roller. The surface of the embossing roller 2 is provided with a relief representing the negative of the grain that is to be given to the surface 10 of the article 1.

A radiation-heating device 3 is placed above the roller 2 to heat the surface to the softening temperature of the surface of article 1.

The equipment further comprises a transferable ink film 11 that originates from a reel 4 and passes between the embossing roller 2 and the article 1 and is wound up on the take-off reel 5 after the operation.

The operation of decorating the surface 10 of the article 1 includes firstly, the embossing of the surface so as to create a texture, and secondly, the printing of a decorative pattern onto this same surface. For this, the plastic article 1, for example made of crystal polystyrene, is fed into the decoration equipment and conveyed under the embossing roller 2 and the film 11. The height of the roller 2 can be adjusted so as to control the pressure exerted by the roller on the film 11 and the surface 10 of the article 1. Because of the heat of the roller 2, the surface 10 is simultaneously embossed by the relief and printed by the ink from the film 11 to afford a surface 10′ that possesses the chosen decoration, i.e. the pattern and the texture. The film 11 is wound up after use on the roller 5.

1. Method for the continuous realisation of a decoration on at least one surface of extruded and foamed plastic articles in one step, said step comprising:
embossing the at least one surface of the article by conveying the article below an embossing roller provided with a surface in relief and
printing the at least one surface of the article by transferring an ink from a transferable ink composite film,
wherein said printing is realised concomitant with the embossing by means of the same embossing roller, the roller being made of an elastic material and heated to the softening temperature of the surface of the plastic article.

2. Method according to claim 1, wherein the elastic material of the embossing roller is silicone rubber.

3. Method according to claim 1, wherein the hardness of the elastic material of the embossing roller is between approximately 40 and 90 Shore A.

4. Method according to claim 1, wherein the extruded and foamed plastic comprises optionally modified thermoplastic (co)polymers including at least one of crystal polystyrene (PS), impact polystyrene (HIPS), poly(styrene-acrylonitrile) (SAN), poly(acrylonitrile-butadiene-styrene) (ABS) and polyvinyl chloride (PVC), as well as their blends, optionally combined with other thermoplastic polymers including polyphenylene oxide (PPO).

5. Method according to claim 1, wherein the softening temperature at the surface is between approximately 160 and 200° C.

6. Device for decorating extruded and foamed plastic articles in one step, said device comprising:
a conveying device for feeding the plastic articles,
an embossing roller provided with a surface in relief,
a heating device for heating the embossing roller,
a feeding reel and a wind-up reel for a transferable ink composite film,
in which the plastic article is moved by the conveying means under the embossing roller that rotates at the conveying speed of the plastic article, said transferable ink composite film coming from the feed reel, being fed between the plastic article and the embossing roller, the embossing roller being made of an elastic material and heated to the softening temperature of the surface of the plastic article.

7. Device according to claim 6, wherein the elastic material of the embossing roller is silicone rubber.

8. Device according to claim 6, wherein the hardness of the elastic material of the embossing roller is between approximately 40 and 90 Shore A.

9. Device according to claim 6, wherein the extruded and foamed plastic comprises optionally modified thermoplastic (co)polymers including at least one of crystal polystyrene (PS), impact polystyrene (HIPS), poly(styrene-acrylonitrile) (SAN), poly(acrylonitrile-butadiene-styrene) (ABS) and polyvinyl chloride (PVC), as well as their blends, optionally combined with other thermoplastic polymers including polyphenylene oxide (PPO).

10. Device according to claim 6, wherein the softening temperature at the surface is between approximately 160 and 200° C.

11. (canceled)

12. The method according to claim 1, wherein the plastic article comprises at least one of a mouldings, skirting boards, picture rails and frames.

13. The device according to claim 6, wherein said plastic article comprises at least one of a moulding, skirting board, picture rail, and frame.
